(19) United States
(12) Patent Application Publication
(10) Pub. No.: US 2022/0388591 A1
(43) Pub. Date: Dec. 8, 2022

(54) PISTOL HOLDER FOR A BICYCLE

(71) Applicant: Stephen Brock, Spring Lake, NC (US)

(72) Inventor: Stephen Brock, Spring Lake, NC (US)

(21) Appl. No.: 17/832,660

(22) Filed: Jun. 5, 2022

Related U.S. Application Data
(60) Provisional application No. 63/196,681, filed on Jun. 4, 2021.

(51) Int. Cl. B62J 11/00

(52) U.S. Cl. CPC B62J 11/00

(57) ABSTRACT

A pistol holder for use holding a pistol on a bicycle is provided. The pistol holder is suited to be attached to a rear bicycle post a distance beneath a seat of a bicycle. The pistol holder is attached using a removable attachment mechanism that clamps around the rear bicycle post and connects with one or more fasteners. The removable attachment mechanism is also removably attachable to a body of the pistol holder that is configured to hold the pistol. The pistol is inserted into the body of the pistol holder so that the pistol is downward facing and facing away from the underside of the bicycle seat. The pistol holder further includes a locking mechanism configured to be toggled to an open position and to a closed position. The finger release locking mechanism temporarily secures and prevents a pistol from being pulled out of the pistol holder body.

### CROSS-REFERENCE TO RELATED APPLICATIONS

This application is a non-provisional application which claims priority to U.S. Provisional Patent Application No. 63/196,681 filed on Jun. 4, 2021, which is incorporated by reference in its entirety.

### FIELD OF THE DISCLOSURE

The present invention relates to a pistol holder for use with a bicycle that can be strategically positioned beneath a seat of a bicycle to provide strategic access to a stored pistol in the pistol holder.

### BACKGROUND

Avid bicyclists frequently travel over many miles over a wide variety of terrain. It has long been felt that bicyclists may benefit from the additional safety and protection offered by having an accessible pistol/handgun close at hand when riding a bicycle that does not interfere with the bicyclist's ability to ride the bicycle or take up valuable storage space on the top bar or bottom bar of the center frame of a bicycle. Currently, there are no available existing options for a pistol holder or holster that can be positioned beneath a bicycle seat that is attachable to a bicycle seat post that would be accessible for a bicyclist and that can further include a lock to lock the pistol within the holster and other beneficial features. Accordingly, there is still a need for such a pistol holder that may be desirable for ensuring safety and also accessibility to the pistol or handgun by a user.

### SUMMARY

The present description includes non-limiting embodiments for a pistol holder that may in particular be suited for attachment to a bicycle for holding and storing a pistol on the bicycle in order to enable a bicyclist to safely transport the pistol when biking. Further, the pistol holder may advantageously attach to a rear bicycle post of the bicycle a distance beneath the seat of the bicycle so that the pistol is easily accessible at any time to the bicyclist. Although, it is noted that the pistol holder described herein may also be removably attachable to other positions on a bicycle, including but not limited to a water bottle mounting mechanism on a bicycle.

In a non-limiting embodiment, the pistol holder described herein includes a a pistol holder body comprising an exterior shell having an interior opening, a top opening, a bottom opening, wherein the interior opening is configured to hold a pistol within the pistol holder oriented in a downward facing direction. The pistol holder further includes an attachment bracket assembly comprising a first attachment bracket piece and a second attachment bracket piece, whereby the first attachment bracket piece comprises a first clamp portion and wherein the second attachment bracket piece comprises a second clamp portion. The pistol holder further includes a locking mechanism. In a non-limiting embodiment, the locking mechanism includes a lever having a post at one end of the lever, wherein the lever of the locking mechanism is configured to be toggled open and closed and may be released or engaged with one finger in one or more non-limiting embodiments. In a non-limiting embodiment, the post extends through a slot in a portion of the pistol holder body and faces inwardly towards the interior opening of pistol holder body. In a non-limiting embodiment, the pistol holder further comprises a bike light or warning light.

In a non-limiting embodiment, the first attachment bracket piece comprises a side projecting piece with one or more holes configured to receive fasteners inserted through the one or more holes of the first attachment bracket. Further, the pistol holder body includes one or more pistol holder body holes configured to receive the fasteners extending through the one or more holes of the first attachment bracket piece in order to removably and fastenably couple the pistol holder body to the first attachment bracket piece of the attachment bracket assembly.

In a non-limiting embodiment, the second attachment bracket piece comprises vertically oriented ribs, and a bike light is configured to slide onto and over the vertically oriented ribs of the second attachment bracket piece.

In another aspect, the present description includes a system for attaching a pistol holder to a bicycle comprising the bicycle and the pistol holder. In a non-limiting embodiment, the bicycle has a seat and a rear bicycle post coupled to an underside of the seat of the bicycle. The pistol holder is attached to the rear bicycle post, wherein a first clamp portion and the second clamp portion of the attachment bracket assembly each have a curved rounded profile configured to clamp around the rear bicycle post. Further, the attachment bracket assembly is configured to be removably attached to the rear bicycle post at any location a distanced beneath the seat of the bicycle.

In another aspect, the present description includes a method of using a pistol holder on a bicycle. The method may include attaching a pistol holder to a rear bicycle post, whereby the rear bicycle post extends vertically away from an underside of a bicycle seat on a bicycle. In a non-limiting embodiment, when the pistol holder is attached, the pistol holder is located a distance below the bicycle seat. The method may further include inserting a pistol into the pistol holder such that the pistol is oriented in a downward direction within a downward facing pocket of the pistol holder, wherein a muzzle or front side of the pistol points downward and away from the bicycle seat. The method may further include locking the pistol within the pistol holder using a locking mechanism integrated on the pistol holder. In a non-limiting embodiment, attaching the pistol holder to the rear bicycle post further comprises attaching an attachment assembly bracket of the pistol holder to the rear bicycle post, whereby a pistol holder body is configured to removably and fastenably connect to a rear side of the attachment bracket.

In a non-limiting embodiment, the method may further include clamping a first clamp portion and a second clamp portion of the attachment bracket assembly around the rear bicycle post of the bicycle and connecting the first clamp portion and the second clamp portion of the attachment bracket assembly with one or more fasteners that extend through one or more holes located in the first clamp portion and the second portion of the attachment bracket assembly. In a non-limiting embodiment, the muzzle or the front side of the pistol extends through a bottom opening of a pistol holder body of the pistol holder. Further, the method may include disengaging the locking mechanism integrated on the pistol holder to extract the pistol.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 depicts a pictorial illustration of an exemplary bicycle and pistol holder.

FIG. 2 depicts a pictorial illustration of a left side view of an exemplary pistol holder attached to a rear bicycle seat post.

FIG. 3 depicts a pictorial illustration of a right side view of an exemplary pistol holder attached to a rear bicycle seat post.

FIG. 4 depicts a pictorial illustration of a pistol holder body and attachment bracket assembly and a rear bicycle post.

FIG. 5 depicts a pictorial illustration of a bike light configured to slide onto the attachment bracket assembly attached to the rear bicycle post.

FIG. 6 depicts a pictorial illustration of a rear view of the fully assembled pistol holder having the attachment bracket assembly attached to the rear bicycle post of a bicycle and the pistol holder body attached to the attachment bracket assembly as well as a bike light.

FIG. 7 depicts a pictorial illustration of a pistol inserted in a pistol holder body attached to a rear bicycle post.

FIG. 8 depicts a pictorial illustration of a partial sectional view of the pistol body holder of the pistol holder and a pistol inserted into the pistol holder with a view of the locking mechanism in a disengaged, open position.

FIG. 9 depicts a pictorial illustration of the partial sectional view of the pistol body holder of the pistol holder and a pistol inserted into the pistol holder with a view of the locking mechanism in an engaged, lock mode.

### DETAILED DESCRIPTION

The present description is drawn to a pistol holder configured to be attached to a rear bicycle post that extends vertically away underneath the bicycle seat of a bicycle. In a non-limiting embodiment, the pistol holder is removably and fastenably attached to the rear bicycle post. Further, the pistol is oriented in a downward facing orientation with the bullet exit opening side of the pistol or muzzle facing away from a rider or user of the bicycle and facing towards a ground surface. The pistol holder, in one or more non-limiting embodiments, may be configured to have a locking mechanism to temporarily lock the pistol within the pistol holder to prevent the pistol from either falling out of the pistol holder or inadvertently being discharged. Further, added benefits are provided by a pistol holder as described herein in one or more non-limiting embodiments in that the pistol holder may include a warning light so as to provide added visibility to other cyclists and vehicles on the road of the presence of the bicyclist, as well as additional pockets for storage. Notably, the pistol holder, as described herein in one or more non-limiting embodiments, is configured to be attached to a bicycle post connected to the underside of a bicyclist's seat, which is a convenient and easy to access location if the cyclist needs to reach down and pull out the pistol from the pistol holder for protection or safety. Further details are provided with respect to the Figures and included in the description below.

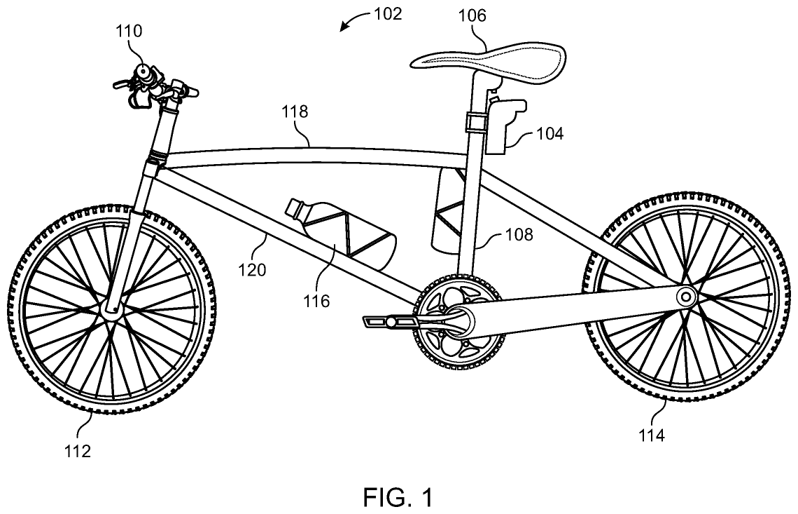

FIG. 1 shows an example bicycle and pistol holder according to one or more non-limiting embodiments. The term “holder” as used herein may be interchangeably used with “holster.” Bicycle 102, as shown in FIG. 1, is an example of a bicycle as known by one of ordinary skill in the art. Bicycle 102 may include a bicycle seat 106 located above a rear bicycle post 108. The bicycle 102 may include handlebars 110 positioned towards the frontside of the frame of the bicycle 102, as well as a front wheel 112 and a back wheel 114. Further, the bicycle 102 may include a center frame structure that includes at least a top bar 118 and a bottom bar 120. Frequently, bicycles 102 may include one or more water bottle attachment mechanisms 116, as shown in FIG. 1, that are attached to either the top bar 118 or bottom bar 120 of the bicycle 102.

Because the storage space or area on the bicycle 102 is so limited, it is important to not take up all of the storage space by the pistol holder 104 and to still provide convenient access points for items such as water bottles that a bicyclist may need while biking, including attachments configured to attach to portions of the bicycle 102, such as the water bottle attachment mechanism 116. Notably, the pistol holder 104 is designed to be compact, portable, and easy to attach and detach from a rear bicycle seat post 108 or another post or part of a bicycle 102. As noted below, in a non-limiting embodiment, the pistol holder 104 may even be mounted to the water bottle attachment mechanism 116.

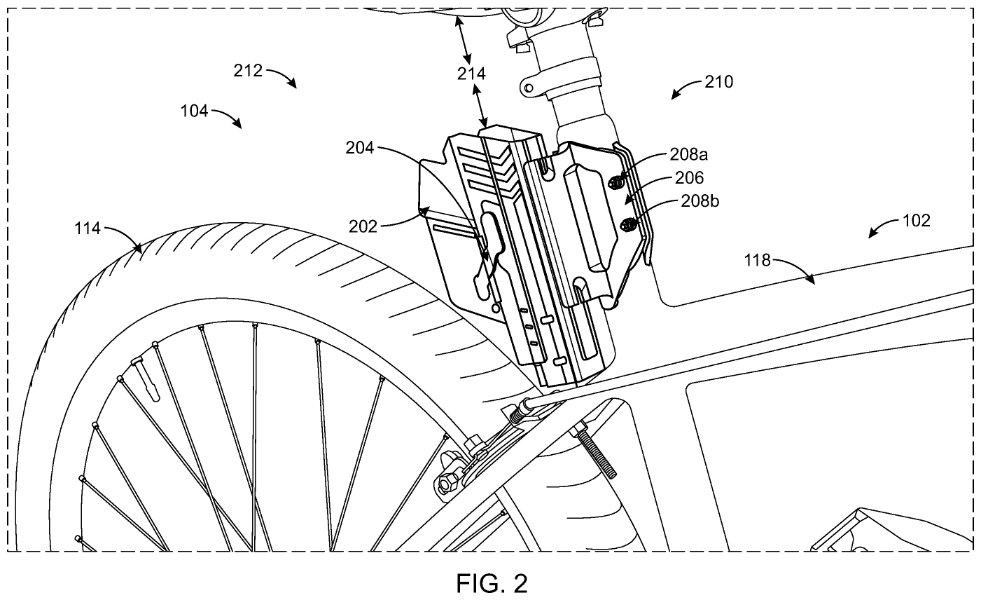

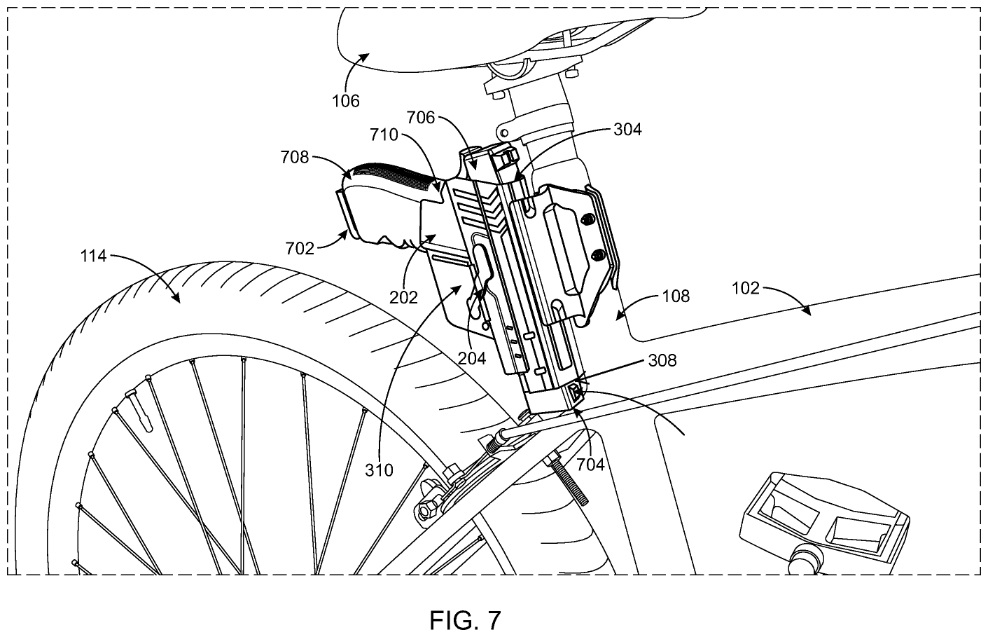

FIG. 2 provides a view of an exemplary pistol holder 104. In a non-limiting embodiment, it may be desirable for the pistol holder to be able to removably attach to a rear bicycle post 108 of the bicycle 102. Locating a pistol holder 104 a distance 214 beneath the seat 106 of the bicycle 102 allows a user to easily store and secure as needed a pistol (e.g., pistol 702 as shown in FIG. 7) in the pistol holder 104 and transport the pistol with the cyclist while biking. Having a pistol (e.g., pistol 702 as shown in FIG. 7) may be particularly beneficial for ensuring the safety of a bicyclist.

As shown in FIG. 2, the pistol holder 104 may be particularly designed to have a downward facing orientation such that the pistol holder faces downward towards a ground surface and away from a bicyclist or user of the bicycle 102. Further, the pistol holder 104 may be positioned behind a rear bicycle post 108 and ahead of a rear wheel 114 of a bicycle 102 in one or more non-limiting embodiments, which may be beneficial so that the user's knees and/or legs are not contacting the pistol holder 104 and are free to pedal the bicycle 102.

As shown in FIG. 2, in a non-limiting embodiment, the pistol holder 104 may comprise a pistol holder body 202, a locking mechanism 204 integrated into the pistol holder body 202, and an attachment bracket assembly 206. The pistol holder body 202 is removably connected to the attachment bracket assembly 206 in one or more non-limiting embodiments. In a non-limiting embodiment, one or more fasteners may be used to removably and fastenably connect the pistol holder body 202 to the attachment bracket assembly 206.

Further, one or more fasteners, including top fastener 208a and bottom fastener 208b may be used to removably couple the pieces of the attachment bracket assembly 206 to the rear bicycle post 108.

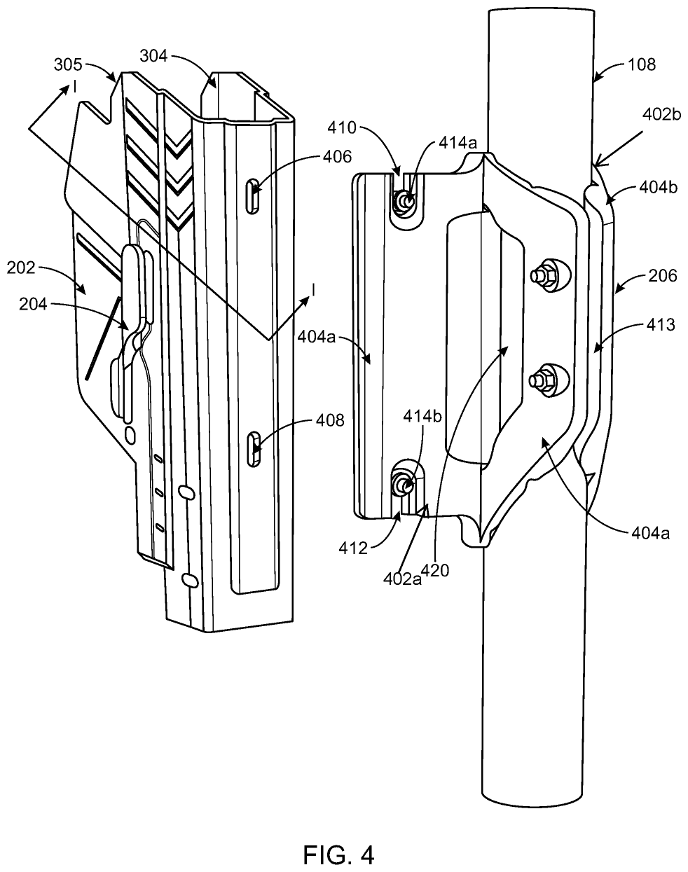

As shown in FIG. 2, when attached to the rear bicycle post 108, the attachment bracket assembly 206 is positioned towards a front 210 of the pistol holder 104 and is removably clamped or attached to the rear bicycle post 108 while the pistol holder body 202 is positioned in the back 212. Notably, a portion of the attachment bracket assembly 206 (e.g., first bracket piece 402a and second bracket piece 402b as shown in FIG. 4) are behind a first clamp portion 404a and a second clamp portion 404b that encircle and clamp around the rear bicycle post 108.

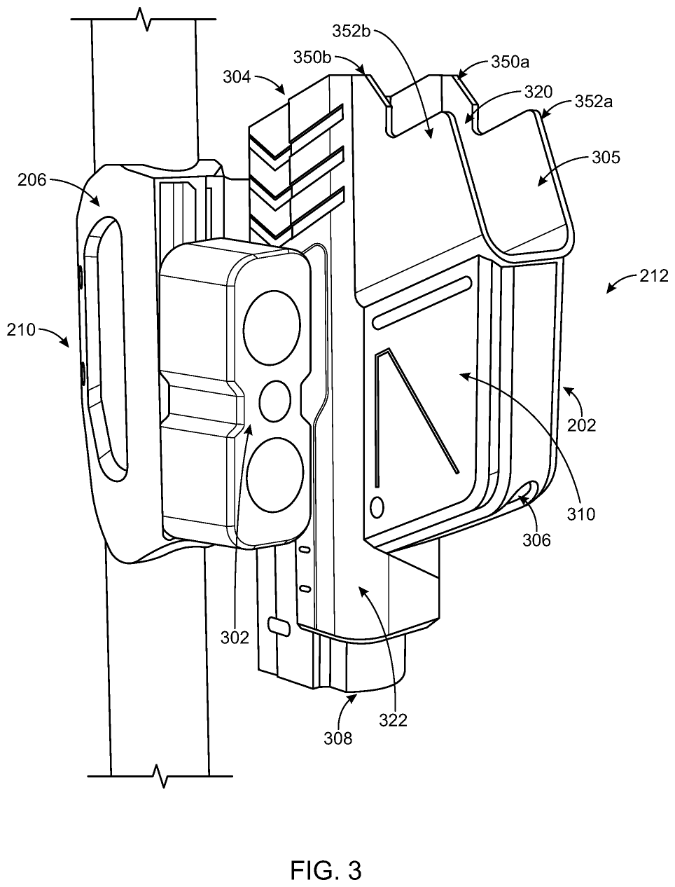

FIG. 2 shows the pistol holder 104 and components from a left side view. FIG. 3 shows the pistol holder 104 and components from a right side view such that a view of the rear 212 of the pistol holder 104 is visible.

As shown in FIG. 3, in a non-limiting embodiment, there may be a bike light 302 that is removably attachable to the pistol holder 104 in one or more non-limiting embodiments. The term “bike light” as used herein may interchangeably be used with “warning light.” In one or more non-limiting embodiments, the bike light 302 is smaller in size and may be vertically oriented as shown in FIG. 3. Further, the bike light 302 may include the use of one or more light emitting diodes (LEDs) to provide a bright and continuous light. In one or more non-limiting embodiments, the bike light 302 may be a flashing light that can be activated by a user or bicyclist using one or more buttons or remote controllers.

As shown in FIG. 3, the pistol holder body 202 has an exterior shell 322 that defines an interior cavity 320. Further, exterior shell 322 of the pistol holder body 202 may be a single, uniform piece that is designed to wholly and solely contain the pistol during use. The pistol holder body 104 may generally be designed to have a profile that is similar in appearance to a handgun or pistol. Notably, the pistol holder body 202 has a top opening 304, a middle opening 306, and a bottom opening 308. FIGS. 7-9 provide exemplary views of how a pistol 702 may appear when oriented in a downward facing orientation into the interior cavity 320 of the pistol holder body 104. A rear portion 305 of the top opening 304 may be open and then join with a central portion 310 of the pistol holder body 104.

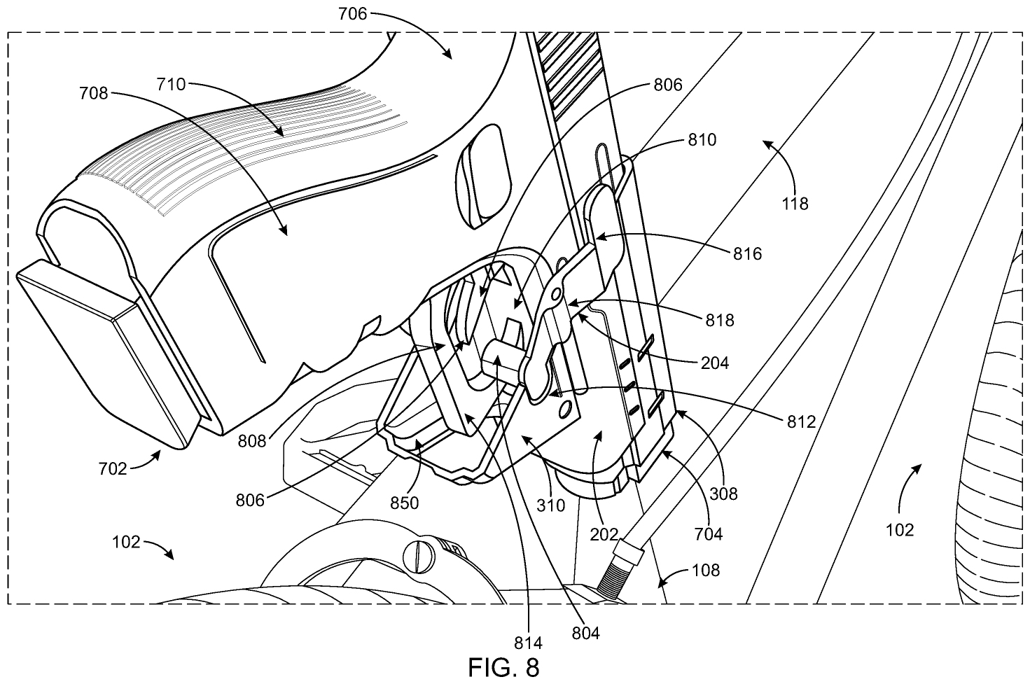

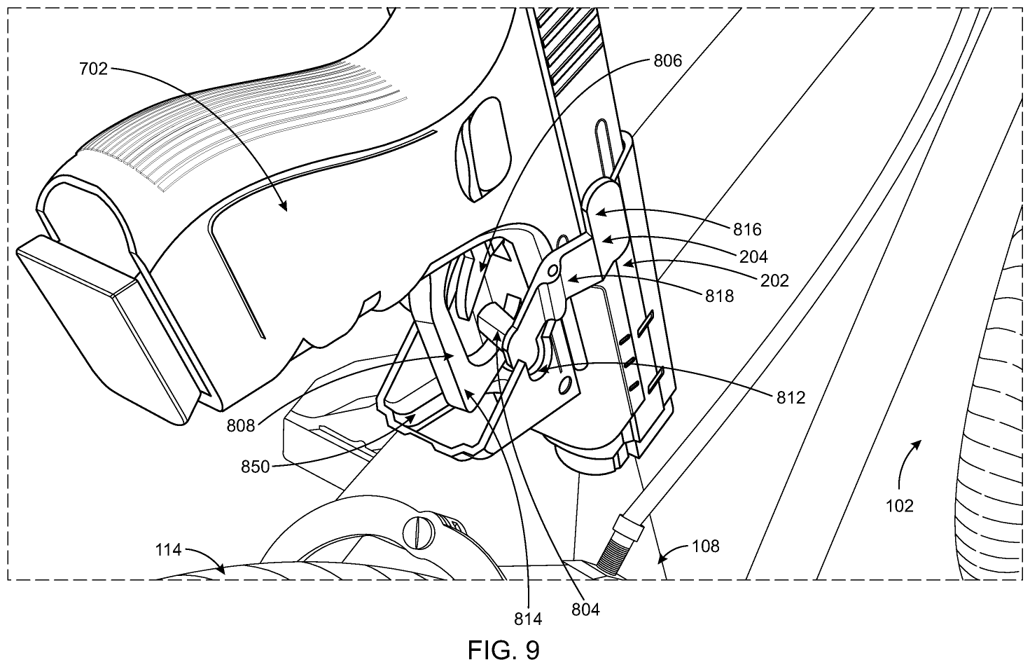

In a non-limiting embodiment, the locking mechanism 204 may be positioned on only one side of the central portion 310 of the pistol holder body 104. As shown in FIG. 3, the locking mechanism 204 is not visible from the right side view of the pistol holder 104 as shown in FIG. 3. FIGS. 8-9 provide further detailed views of the locking mechanism 204 and its structure within the pistol holder body 202 according to one or more non-limiting embodiments.

In a non-limiting embodiment, there may be one or more stepped walls or ridges such as stepped walls or ridges 350a, 350b and lower stepped walls or ridges 352a, 352b incorporated into the shell 322 of the pistol holder body 202 in one or more non-limiting embodiments. The stepped walls or ridges 350a, 350b, 352a, 352b, as shown in FIG. 3, may be included to provide a tighter more constrained hold on the pistol 702 to prevent the pistol 702 from moving around when contained within the pistol holder body 202. In other embodiments, the stepped walls or ridges 350a, 350b, 352a, 352b may be omitted and replaced with angled edges or curved edges of the shell 622 walls that define the interior opening 320 and the top opening 304 of the pistol holder body 202.

FIG. 4 is a partially exploded view showing the attachment assembly bracket 206 fastenably attached to the rear bicycle post 108 of the bicycle 102 and the pistol holder body 202 shown separated from the attachment assembly bracket 206 but oriented in a correct manner for attaching the pistol holder body 202 to the attachment assembly bracket 206.

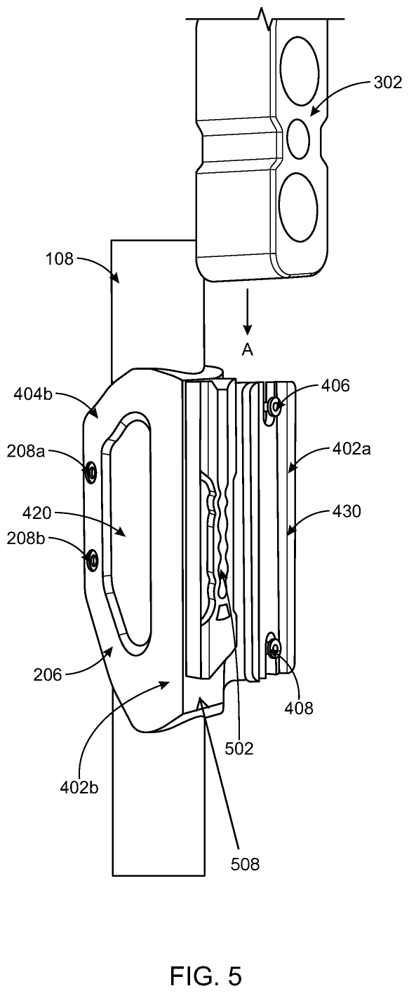

In a non-limiting embodiment, the attachment assembly bracket 206 includes a first bracket attachment piece 402a and a second bracket attachment piece 402b as shown in FIG. 4. In a non-limiting embodiment, the first bracket attachment piece 402a and the second bracket attachment piece 402b are joined by a common back piece 508, as shown in FIG. 5. In other non-limiting embodiments, the first bracket attachment piece 402a and the second bracket attachment piece 402b are separate pieces not sharing a common back piece 508.

In a non-limiting embodiment, the first bracket attachment piece 402a includes a first clamp portion 404a and the second bracket attachment piece 402b comprises a second clamp portion 404b. The first clamp portion 404a and the second clamp portion 404b may be similarly designed to have a curved, rounded shape configured to curve around a rounded bicycle post, such as, but not limited to, the rear bicycle post 108 of a bicycle 102.

Advantageously, in a non-limiting embodiment, the first clamp portion 404a and the second clamp portion 404b each include fastener openings or holes so that one or more fasteners, such as top fastener 208a and bottom fastener 208b, as shown in FIG. 2 and in FIG. 4, can extend through the aligned fastener openings or holes in the first clamp portion 404a and the second clamp portion 404b in order to fastenably secure the entire attachment bracket assembly 206 around and/or to the rear bicycle post 108 of the bicycle 102. As shown in FIG. 4, there may be a gap 413 between the first clamp portion 404a and the second clamp portion 404b in one or more non-limiting embodiments, although that gap 413 can also be omitted in other non-limiting embodiments.

Notably, the user does not have to drill into the bicycle post 108 of the bicycle 102 or damage the structure of the bicycle 102 in anyway when attaching the pistol holder 104 to the bicycle post 108, including attaching the attachment bracket assembly 206 to the bicycle post 108 of the bicycle. Rather, the pistol holder 104 is designed such that the attachment assembly bracket 206 and the first attachment piece 402a and the second attachment piece 402b removably and fastenably couple to the posts (e.g., rear bicycle seat post 108) of the bicycle 102.

There may be an additional gap or separation 420 between the first clamp portion 404a and the first attachment piece 402a, as well as between the second clamp portion 404b and the second attachment piece 402b. In a non-limiting embodiment, the first attachment piece 402a includes a side projecting piece 430 that projects outwardly to the left and away from the first attachment piece 402a of the attachment bracket assembly 206. Further, there may be one or more upper and lower fastener holes 414a, 414b integrated respectively into an upper portion 410 and a lower portion 412 of the side projecting piece 430 of the first attachment piece 402a of the attachment bracket assembly 206. As shown in FIG. 4, there may be upper and lower fastener holes 406, 408 on the pistol holder body 202 that align with the upper and lower fastener holes 414a, 414b of the first attachment piece 402a and the side projecting piece 430 in a non-limiting embodiment. A user may insert one or more fasteners through the upper and lower fastener holes 414a, 414b of the first attachment piece 402a of the attachment bracket assembly 206 through the upper and lower fastener holes 406, 408 of the pistol holder body 202 to fastenably and removable couple the pistol holder body 202 to the attachment bracket assembly 206.

As shown in FIG. 4, the pistol holder body 202 is configured to be oriented with the top opening 304 above the bottom opening 308 of the pistol holder body 202 such that the pistol holder body 204 is oriented in a downwards orientation. This may further ensure the safety of the user as the pistol is intended to be positioned facing downwards also.

FIG. 5 shows a right side view of the attachment bracket assembly 206 according to a non-limiting embodiment. In the pictorial illustration shown in FIG. 5, the side projecting piece 430 of the first attachment bracket piece 402a of the attachment bracket assembly 206 is shown without the pistol holder body 202 coupled to the first attachment piece 402a. The upper and lower fastener holes 414a, 414b extend through the side projecting piece 430 and are vertically aligned with one another in order to align with the upper and lower fastener holes 406, 408 of the pistol holder body 202 as noted above and shown in FIG. 4.

Further, in a non-limiting embodiment, as shown in FIG. 5, the second attachment piece 402b may include one or more vertically oriented ribs 502. As shown in FIG. 5, in a non-limiting embodiment, the bike light 302 may be configured to slide onto and fit over the vertically oriented ribs 502 integrated into the second attachment piece 402b.

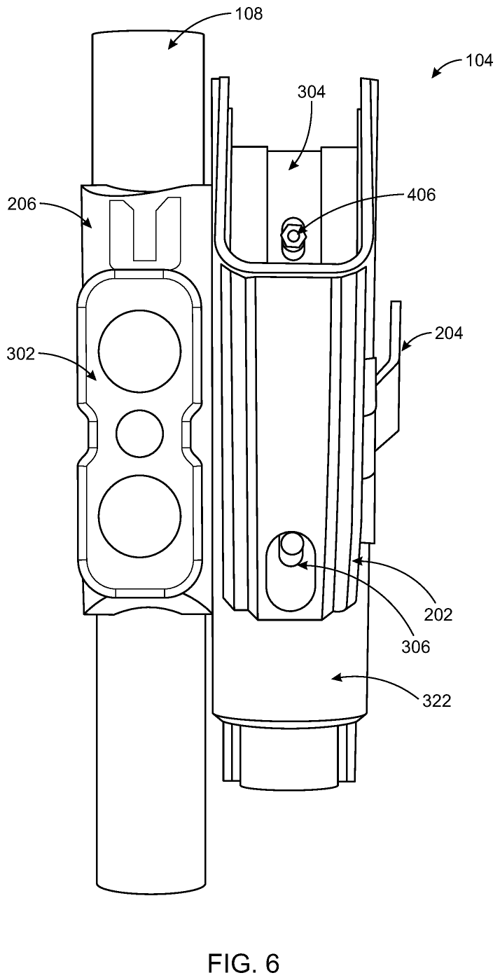

FIG. 6 further displays how the bike light 302 may be positioned behind the rear bicycle post 108 onto the second attachment piece 402b of the attachment assembly bracket 206 while the pistol holder body 202 is projecting to one side of the rear bicycle post 108 of the bicycle 102. The form and structure of the pistol holder 104 and its components, including the pistol holder body 202 and the attachment bracket assembly 206 may be optimally positioned because the attachment bracket assembly 206 and the components of the pistol holder 104 do not protrude out extensively from behind the rear bicycle post 108. Rather, as shown in FIG. 2 and in FIGS. 7-9, the pistol holder 104 is well-positioned and contained against the back of the rear bicycle post 108.

FIG. 7 depicts an example pistol 702 positioned in the pistol holder 104 that is attached to the back of the rear bicycle post 108. A pistol 702 is a type of weapon and a type of small handheld firearm or small handgun in particular. The terms “pistol” and “handgun” and/or “handheld firearm” may be used interchangeably herein. A number of different types of pistols may be adapted to fit within the pistol body 202 of the pistol holder 104. Some examples include, but are not limited to, GLOCK pistols. GLOCK pistols are well-known pistols that are semi-automatic. Many other types of manufactured pistols or small handheld firearms may also be inserted and positioned in the pistol holder 104 as well in one or more non-limiting embodiments. Notably, the pistol holder 104 can also be manufactured in multiple sizes to accommodate smaller sized or larger sized handguns that can be attached to the bicycle and transported safely while a cyclist cycles or bikes for any period of time.

As shown in FIG. 7, the pistol 702 includes a front side or muzzle 704. The front side or muzzle 704 is also where the bullet exit opening is located in the pistol 702. The pistol 702 includes a rear side 706 and a handle 708 that protrudes from a bottom of the pistol 702. The magazine holding the bullets is typically insertable through the defined cavity within the handle 708 of the pistol 702. When positioned in the pistol holder body 202, the pistol 702 is oriented in a downwards facing orientation such that the muzzle 704 extends through the interior cavity 320 of the pistol holder body 202, as shown for example in FIG. 3. As shown in FIG. 7, the muzzle 704 of the pistol 702 may visibly extend past the bottom opening 308 on the lower end of the pistol holder body 202. The pistol rear 706 may visibly protrude above a top opening 304 of the pistol holder body 202. Further, the handle 708 protrudes outwardly away through the rear portion 305 of the top opening 304 of the pistol holder body 202. As shown in FIG. 7, the pistol 702 is located generally beneath the seat 106 of the bicycle 102 and not interfering with the ability of the bicyclist to bike or pedal.

FIG. 8 shows that the pistol 702 further may include a trigger guard 808 defining a trigger guard opening 810 which contains the trigger 806 to fire a bullet out of the muzzle 704 of the pistol 702.

The locking mechanism 204 is visible in the side shown in FIG. 7. In a non-limiting embodiment, it is intended that a user may use one finger to strike or contact the locking mechanism 204 to toggle the locking mechanism 204 from a locked to an open position while using another hand to withdraw the pistol 702 or the same hand if needed. This may make it easy for the user to easily withdraw the pistol 702 from the pistol holder 104.

FIG. 8 and FIG. 9 are partial sectional views taken along line I-I shown in FIG. 4. FIG. 8 and FIG. 9 provide a more detailed view of an example pistol 702 positioned within the pistol holder 104 and how the locking mechanism 204 may interact with the pistol 702 to temporarily secure the pistol 702 in place. FIG. 8 shows the locking mechanism 204 in an open, unlocked or disengaged position and FIG. 9 shows the locking mechanism 204 in a closed, locked or engaged position.

In a non-limiting embodiment, the locking mechanism 204 includes a tab 816 that connects or is formed with a middle elongated lever 818 piece and a smaller sized post 804 formed at the end of the locking mechanism 204. The term “post” may interchangeably be used herein with the term lock or button.

Notably, the post 804 is opposite the location of the tab 816. The locking mechanism 204 is configured to toggle forward and back between an engaged and disengaged position or a closed and open position.

The post 804 extends through a slot 812 formed in the central portion 310, as shown in FIG. 3, of the pistol holder body 202. The central portion 310 of the pistol holder body 202 is also the portion of the pistol holder body 202 intended to contain the trigger guard 808 of the pistol 702. The central portion 310 includes an interior cavity 850 as shown in FIGS. 8-9 dedicated to holding and containing the trigger guard 808 in a non-limiting embodiment.

As shown in FIG. 8, in a non-limiting embodiment, when the post 804 of the locking mechanism 204 is retracted and flush or covering the main opening of the slot 812 of the central portion 310 of the pistol holder body 202, then the trigger guard 808 and specifically a bottom or lower member 814 of the trigger guard 808 is not blocked by the post 804 of the locking mechanism 204, such that the pistol 702 may be pulled up and away from the pistol holder body 202.

As shown in FIG. 9, in a non-limiting embodiment, when the post 804 of the locking mechanism 204 is engaged and extended forward and is no longer covering the main opening of the slot 812 of the central portion 310 of the pistol holder body 202 and the post 804 is in the way to block upward movement of the bottom member 814 of the trigger guard 808. Accordingly, the bottom or lower member 814 of the trigger guard 808 is obstructed and the pistol 702 may not be pulled up and out of the pistol holder body 202 according to this one, exemplary non-limiting embodiment. Accordingly, as mentioned above, and shown in FIGS. 8-9, the locking mechanism 204 acts as a temporary lock and is intended to be easily engaged or disengaged to insert and extract the pistol 702 as needed.

It is noted that in a non-limiting embodiment, the pistol holder 104 may include one or more ports, such as a mini-USB port, so that the user can charge the one or more LED lights or other devices, such as the user's cell phone or other smart device. Additionally, the pistol holder may include one or more exterior pockets that can hold various personal documents or identification, such as driver licenses, credit cards, or any other personal items the bicyclist desires.

Notably, cyclists often travel many miles through unknown and unfamiliar neighborhoods or streets. Having an additional means for ensuring personal safety or the safety of others provides greater peace of mind and security to the cyclist. Further, the design and structure of the pistol holder 104 as described herein allows the cyclist to attach the pistol holder 104 to the rear bicycle post 108 of the bicycle 102 and ensure the pistol is nearby and within convenient reach if needed, but without interfering with the cyclist when cycling or taking up space on other areas of the bicycle 102 that may be needed for other items, such as a water bottle, cell phone, or other devices.

In another non-limiting embodiment, the pistol holder body 202 can be mounted in a location other than the rear bicycle post 108. For example, the pistol holder body 202 may usefully be mountable to a water bottle attachment mechanism, such as water bottle attachment mechanism 116 shown in FIG. 1. The pistol holder body 202, is advantageously, separate from the attachment bracket mechanism 206, which means that the user can use fasteners that are insertable through top fastener opening 406 and bottom fastener opening 408 of the pistol holder body 202, and through corresponding holes on a water bottle attachment mechanism 116 already incorporated or that is attachable to a bottom bar 120 of the bicycle 102. Accordingly, the pistol holder body 202 and enclosed pistol 702 is still within reach of the user when biking.

Many other advantages and benefits may be provided by the pistol holder 104 as described herein.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted. The term “coupled to” as used herein may refer to a direct or indirect connection. The term “set” as used herein may refer to “one or more” of any item or step.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A pistol holder, comprising:
a pistol holder body comprising an exterior shell having an interior opening, a top opening, and a bottom opening, wherein the interior opening is configured to hold a pistol within the pistol holder oriented in a downward facing direction;
an attachment bracket assembly comprising a first attachment bracket piece and a second attachment bracket piece that are attached to a common back piece of the attachment bracket assembly,
wherein the first attachment bracket piece comprises a first clamp portion,
and wherein the second attachment bracket piece comprises a second clamp portion; and
a locking mechanism, wherein the locking mechanism includes a lever having a post at one end of the lever, wherein the lever of the locking mechanism is configured to be toggled open and closed, whereby the post extends through a slot in a portion of the pistol holder body and faces inwardly towards the interior opening of the pistol holder body.

2. The pistol holder of claim 1, wherein the pistol holder further comprises a bike light or warning light.

3. The pistol holder of claim 1, wherein the first attachment bracket piece comprises a side projecting piece with one or more holes configured to receive fasteners inserted through the one or more holes of the side projecting piece of the first attachment bracket.

4. The pistol holder of claim 3, wherein the pistol holder body includes one or more pistol holder body holes configured to receive the fasteners extending through the one or more holes of the side projecting piece of the first attachment bracket piece in order to removably and fastenably couple the pistol holder body to the first attachment bracket piece of the attachment bracket assembly.

5. The pistol holder of claim 1, wherein the second attachment bracket piece comprises vertically oriented ribs.

6. The pistol holder of claim 1, further comprising, a bike light or warning light configured to slide onto and over the vertically oriented ribs of the second attachment bracket piece.

7. A system for attaching a pistol holder to a bicycle, comprising:
the bicycle having a seat and a rear bicycle post coupled to an underside of the seat of the bicycle; and
a pistol holder comprising:
a pistol holder body comprising an exterior shell having an interior opening, a top opening, and a bottom opening, wherein the interior opening is configured to hold a pistol within the pistol holder in a downward facing orientation;
an attachment bracket assembly comprising a first attachment bracket piece and a second attachment bracket piece,
wherein the first attachment bracket piece comprises a first clamp portion having a curved rounded profile configured to clamp around the rear bicycle post,
and wherein the second attachment bracket comprises a second clamp portion having the curved rounded profile configured to clamp around the rear bicycle post; and
a locking mechanism to temporarily hold and secure the pistol within the pistol holder body,
wherein the attachment bracket assembly is configured to be removably attached to the rear bicycle post at any location a distance beneath the seat of the bicycle.

8. The system of claim 7, wherein the locking mechanism is a finger release locking mechanism that can be triggered to toggle open or closed with one finger.

9. The system of claim 7, wherein the locking mechanism includes a lever piece with a post positioned at an end of the lever piece that extends through a slot in a portion of the pistol holder body, and wherein the pistol is held in place within the pistol holder body when the post is toggled to a closed position such that the post of the locking mechanism blocks a lower piece of the trigger guard from being pulled up and out of the pistol holder body without first toggling open the lever piece of the locking mechanism.

10. The system of claim 9, wherein when the lever piece of the locking mechanism is toggled open, the post of the lever piece of the locking mechanism is retracted such that the lower piece of the trigger guard is unobstructed by the post of the lever piece of the locking mechanism, and the pistol is not prevented from being pulled up and out of the pistol holder body.

11. The system of claim 7, wherein a front side or muzzle of the pistol extends through the bottom opening of the pistol holder body of the pistol holder when the pistol is positioned within the pistol holder body having the downward facing orientation.

12. The system of claim 7, wherein a rear side of the pistol is visible through a rear area of the top opening when the pistol is contained within the interior opening of the pistol holder body and when the pistol is positioned within the pistol holder body having the downward facing orientation.

13. The system of claim 7, wherein the first attachment bracket piece comprises a side projecting piece with one or more holes configured to receive fasteners inserted through the one or more holes of the side projecting piece of the first attachment bracket piece.

14. The system of claim 13, wherein the pistol holder body includes one or more pistol holder body holes configured to receive the fasteners extending through the one or more holes of the side projecting piece of the first attachment bracket piece in order to removably and fastenably couple the pistol holder body to the first attachment bracket piece of the attachment bracket assembly.

15. A method of using a pistol holder on a bicycle, the method comprising:
attaching a pistol holder to a rear bicycle post, wherein the rear bicycle post connects to an underside of a bicycle seat on a bicycle, wherein when attached, the pistol holder is located a distance below the bicycle seat;
inserting a pistol into the pistol holder such that the pistol is oriented in a downward direction within a downward facing pocket of the pistol holder, wherein a muzzle or front side of the pistol points downward and away from the bicycle seat; and
locking the pistol within the pistol holder using a locking mechanism integrated on the pistol holder.

16. The method of claim 15, wherein attaching the pistol holder to the rear bicycle post further comprises:
attaching an attachment assembly bracket of the pistol holder to the rear bicycle post, wherein a pistol holder body is configured to removably and fastenably connect to a rear side of the attachment bracket.

17. The method of claim 15, further comprising:
clamping a first clamp portion and a second clamp portion of an attachment bracket assembly around the rear bicycle post of the bicycle; and
connecting the first clamp portion and the second clamp portion of the attachment bracket assembly with one or more fasteners that extend through one or more holes located in the first clamp portion and the second clamp portion of the attachment bracket assembly.

18. The method of claim 15, wherein the muzzle or the front side of the pistol extends through a bottom opening of a pistol holder body of the pistol holder.

19. The method of claim 15, further comprising, disengaging the locking mechanism integrated on the pistol holder to extract the pistol.

20. The method of claim 19, wherein the locking mechanism comprises a lever piece with a post at an end of the lever piece, wherein the post is oriented facing inwards into a slot that is part of a portion of a pistol holder body.
